(19) United States
(12) Patent Application Publication
(10) Pub. No.: US 2007/0172214 A1
(43) Pub. Date: Jul. 26, 2007

(54) Optical disc signal reproducing device

(75) Inventor: Ryosuke Nakamura, Daito (JP)

Correspondence Address: BACON & THOMAS, PLLC, 625 SLATERS LANE, FOURTH FLOOR, ALEXANDRIA, VA, 22314, US

(73) Assignee: FUNAI Electric Co., Ltd., Daito (JP)

(21) Appl. No.: 11/656,408

(22) Filed: Jan. 23, 2007

(30) Foreign Application Priority Data
Jan. 24, 2006 (JP) 2006-15393

(51) Int. Cl. H04N 5/00

(52) U.S. Cl. 386/126

(57) ABSTRACT

An adapted to output video signals reproduced from an optical disk and audio signals of two languages selected in advance, enabling dubbing of the video signals and two language audio signals on another recording medium.

The optical disk signal reproducing device is configured to reproduce audio/video signals recorded on an optical disk at high multiplex speed, separate the reproduced audio/video signals into audio signals and video signals, expand and decode the video signals, encode the decoded video signals to video signals of a predetermined signal system, convert the encoded video signals into analog signals, outputs the analog signals, expand and decode the audio signals down-mix and convert the decoded audio signals into monaural main and secondary voice signals of the two languages selected in advance, convert the monaural main voice signals into analog signals, output the analog main voice signal, convert the monaural secondary voice signals into analog signals, and output the analog secondary voice signal.

### BACKGROUND OF THE INVENTION

1. Field of the Invention

The present invention relates to an optical disc signal reproducing device for reproducing audio/video signals recorded on an optical disc, and more particularly relates to an optical disc signal reproducing device which can output audio signals of two languages recorded on an optical disc.

2. Description of the Prior Art

In general, optical disc signal reproducing devices which reproduce audio/video signals recorded on an optical disc such as a DVD (Digital Versatile Disc), are configured to reproduce and output high quality audio signals and video signals. However, conventional optical disc signal reproducing devices are configured to output either one of main voice and secondary voice selected by a user even if audio signals of two languages are recorded on the optical disc, in case the optical disc signal reproducing device is provided with a single audio decoder. Accordingly, the conventional devices have a problem that, when the audio/video signals recorded on the optical disc is dubbed, the audio signals of a selected one of the two languages recorded on the optical disc are outputted but the audio signals of two languages can not be dubbed simultaneously on a recording medium such as a video tape.

Japanese Unexamined Patent Application Publication No. 8-77763 discloses a system in which, when audio signals are transmitted to a plurality of audio/video devices provided in signal transmission paths in an audio/video system in which a plurality of audio/video devices are connected to an audio/video center through control buses, audio signals of two languages or stereo sound are transmitted and audio/video devices at output stages are set to two language or stereo sound outputting mode in case all of the plurality of audio/video devices are adapted for two language and/or stereo sound outputting.

Japanese Registered Utility Model Publication No. 3094355 discloses a complex audio/video device which simultaneously receives audio/video signals received by a tuner or audio/video signals recorded by a digital video camera, and audio signals reproduced from an optical disc, and which records on a video tape two different kind of audio signals for a single kind of video signals.

Of the above-mentioned disclosed technologies, the former system is arranged such that, for the transmission of audio signals to a plurality of audio/video devices in the signal transmission paths, two language or stereo sound audio signals can be transmitted and the audio/video devices can be set to two language or stereo sound outputting mode only when all of the plurality of audio/video devices are adapted for the two language or stereo sound outputting. Although the system enables switching among only main sound outputting, only secondary sound outputting and simultaneous main and secondary sound outputting by setting the audio/video devices at the output stage to the two language or stereo sound mode in case all of the audio/video devices are adapted for the two language or stereo sound outputting, it is not free from the above mentioned problem of the conventional devices.

The latter can simultaneously receive audio/video signals received by a tuner or audio/video signals recorded by a digital video camera, and audio signals reproduced from an optical disc, and record on a video tape two different kind of audio signals for a single kind of video signals, and arranged to record, on a video tape, audio signals reproduced from an optical disc when audio/video signals of television broadcasting or audio/video signals recorded by a video camera are recorded on a video tape, but it is not arranged to be free from the above mentioned problem of the conventional devices.

### SUMMARY OF THE INVENTION

An object of the present invention is to provide an optical disc signal reproducing device which outputs video signals reproduced from an optical disc and audio signals of pre-selected two languages and dubs on another recoding medium the video signals and the two language audio signals.

To attain the above-mentioned object, an optical disc signal reproducing device for reproducing and outputting audio/video signals recorded on an optical disk according to the present invention comprises a selection unit for selecting in advance two languages of a main voice and secondary voice, a reproducing unit for reproducing at multi-speed the audio/video signals recorded on an optical disc, a stream separating unit for separating the audio/video signals reproduced by the reproducing means into video signals and audio signals, a first buffer unit for storing the video signals separated by the separating unit, a second buffer unit for storing the audio signals separated by the separating unit, a first decoding unit for expanding and decoding the video signals stored in the first buffer unit, an encoding unit for encoding the video signals decoded by the first decoding unit to video signals of a predetermined signal system, a first DA converting unit for converting the video signals encoded by the first encoding unit to analog signals and outputting the analog signals, a second decoding unit for expanding and decoding the audio signals stored in the second buffer unit and converting the decoded audio signals into monaural main and secondary voice signals of the two languages selected in advance by the selection unit, a third buffer unit for storing the main voice signals converted into the monaural signals by the second decoding unit, a fourth buffer unit for storing the secondary voice signals converted into the monaural signals by the second decoding unit, a second DA converting unit for converting the monaural main voice signals stored in the third buffer unit into analog signals and outputting the analog signals, and a third DA converting unit for converting the monaural secondary voice signals stored in the fourth buffer unit into analog signals and outputting the analog signals.

According to the optical disc signal reproducing device configured as mentioned above, video signals reproduced from an optical disc and audio signals of two languages selected in advance are outputted and can be dubbed in another recording medium.

### BRIEF DESCRIPTION OF THE DRAWINGS

FIG. 1 is a block diagram showing a configuration of an optical disc signal reproducing device according to an embodiment of the present invention.

FIG. 2 is a plan view of a remote control of the optical disc signal reproducing device according to the embodiment of the resent invention.

FIG. 3 shows an example of display on an audio output setting screen of the optical disc signal reproducing device according to an embodiment of the present invention.

FIG. 4 is a flowchart showing operation of the optical disc signal reproducing device shown in FIG. 1.

FIG. 5 is a flowchart showing operation of the optical disc signal reproducing device shown in FIG. 1.

FIG. 6 is a flowchart showing operation of the optical disc signal reproducing device shown in FIG. 1.

### DESCRIPTION OF THE PREFERRED EMBODIMENT

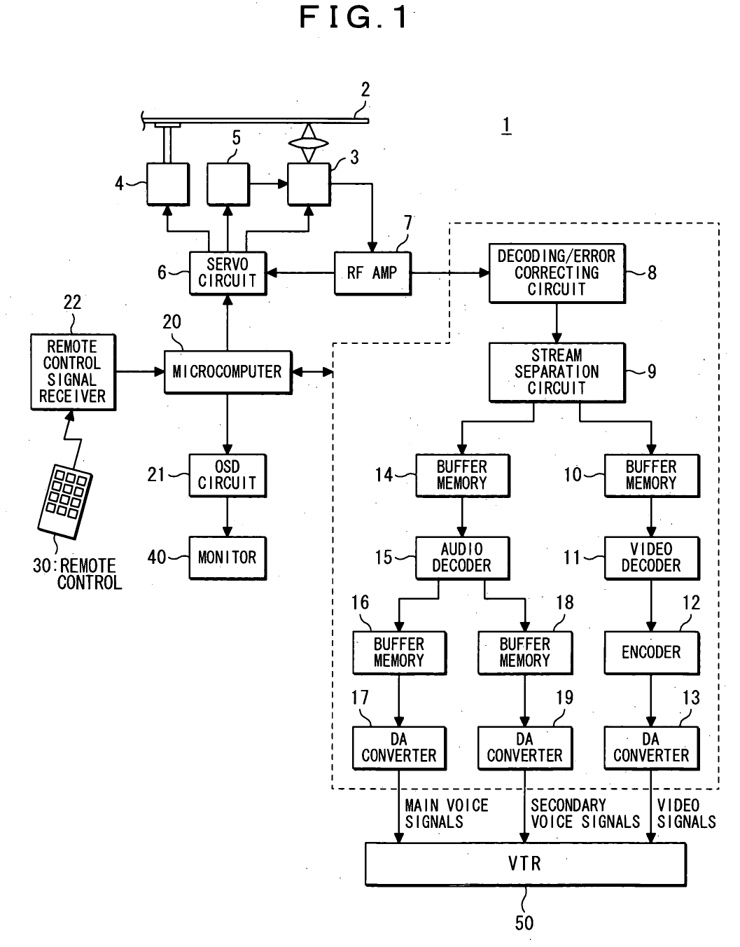

A preferred embodiment of an optical disc signal reproducing device according to the present invention will be described hereinafter with reference to the drawings. First, description will be made of a configuration of the optical disc signal reproducing device according to the embodiment of the present invention with reference to the block diagram shown in FIG. 1.

The optical disc signal reproducing device 1 is generally referred to by a reference numeral 1. The optical disc signal reproducing device comprises an optical pickup 3, a spindle motor 4, a thread motor 5, a servo circuit 6, and a RF amplifier circuit 7. The optical pickup 3 projects laser beam on an optical disc 2 and detects the laser beam reflected therefrom to read out audio/video signals recorded on the optical disc 2. The spindle motor 4 rotates the optical disc 2. The thread motor 5 moves the optical pickup 3 in radial direction of the optical disc 2 for thread transferring. The servo circuit 6 servo controls the rotational speed of the spindle motor 4 and the rotational direction and speed of the thread motor 5 to servo control the tracking and focus of the optical pickup in accordance with tracking error signal and focus error signal detected by the optical pickup 3. The RF amplifier circuit 7 amplifies the RF (Radio Frequency) signals of the audio/visual signals read out by the optical pickup 3.

The optical disc signal reproducing device 1 further comprises a decoding/error-correcting circuit 8, a stream separation circuit 9, a buffer memory 10, a video decoder 11, an encoder 12, a DA (Digital to Analog) converter circuit 13, a buffer memory 14, an audio decoder 15, a buffer memory 16, a DA converter circuit 17, a buffer memory 18 and a DA converter circuit 19.

The decoding/error-correcting circuit 8 synchronously detects and decodes the RF signals of the audio/video signals in response to standard clock signals, and corrects errors in the decoded audio/video signals. The stream separation circuit 9 separates the audio/video signals into video signals and audio signals. The buffer memory 10 stores the video signals separated by the stream separation circuit 9. The video decoder 11 expands and decodes the video signals compressed in accordance with a predetermined compression system. The encoder 12 encodes DA (Digital to Analog) signals into video signals of a predetermined signal system such as NTSC (National Television System Committee) system. The DA converter circuit 13 converts the digital video signals which have been encoded into the signals of the predetermined signal system, into analog signals and outputs the analog signals to a VTR (Video Tape Recorder) device 50.

The buffer memory 14 stores the audio signals separated by the stream separation circuit 9. The audio signal decoder 15 expands and decodes the audio signals which have been compressed in accordance with a predetermined compression system, down-mixes the decoded audio signals and converts the down-mixed audio signals into monaural main voice signals and monaural secondary voice signals. The buffer memory 16 stores the monaural main voice signal. The DA converter circuit 17 converts the digital monaural main voice signals stored in the buffer memory 16 into analog signals and outputs the analog signals to the VTR device 50. The buffer memory 18 stores the monaural secondary voice signal. The DA converter circuit 19 converts the digital monaural secondary voice signals stored in the buffer memory 18 into analog signals and outputs the analog signals to the VTR device 50.

The optical disc signal reproducing device 1 further comprises a microcomputer 20 for controlling the entire system of the optical disc signal reproducing device 1, an OSD (On-Screen Character Display) circuit 21 for displaying character information signal by superimposing it on video signal on a monitor device 40, and a remote control signal receiver 22 for receiving infrared remote control signals transmitted from the remote control 30 and converts the received signals into signals of a predetermined type.

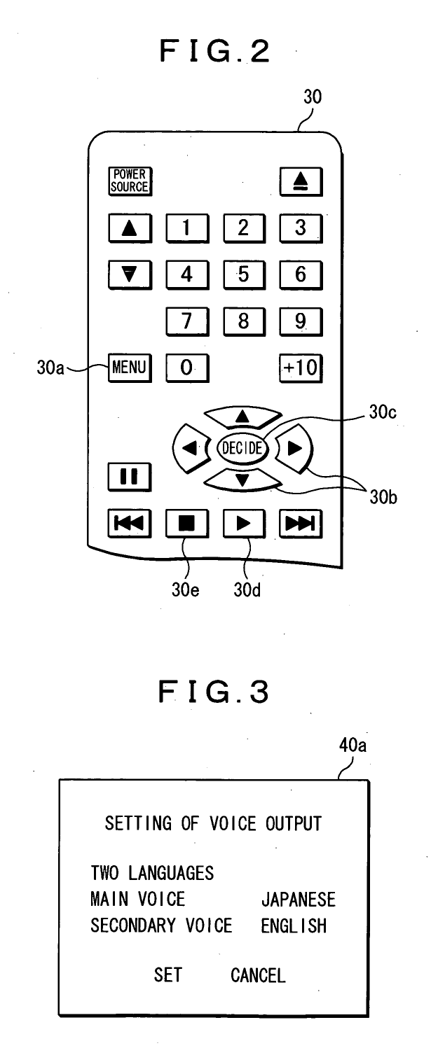

As shown in FIG. 2, the remote control 30 is provided with a menu key 30a for instructing display of a menu screen for the setting of various functions of the optical disc signal reproducing device 1, a cursor key 30b for the selection of items, a decision key 30c for the decision of the selection of the item selected by the cursor key 30b, a reproduction key 30d for instructing reproduction of signals stored on the optical disk 2, and a stop key 30e for instructing stop of the reproduction of the signals stored on the optical disk 2, so that the optical disk signal reproducing device 1 may operates as desired in response to operation on the keys.

Then, description will be made of the operation of the optical disc signal reproducing device 1 configured as mentioned above. When a user wishes to reproduce video signals and two language audio signals recorded on the optical disc 2 and dub the video signals and the audio signals on a video tape (not shown) installed in the VTR device 50, the user may select two languages to be outputted from the optical disc signal reproducing device 1 by voice and specify one of the selected languages as a main voice language and the other as a secondary voice language. In more detail, when the user operates the key 30a of the remote control 30 to instruct display of menu screen, and operates the cursor key 30b and the decision key 30c of the remote control 30 to select display of the voice outputs setting screen (not shown) from the menus displayed on the screen, the microcomputer 20 supplies character data signals and control signals to the OSD circuit 21 to display a voice output setting screen (see FIG. 3) on the screen 40a of the monitor device 40. Then, the user may operate the cursor key 30b and the decision key 30c of the remote control 30 to select two languages with reference to a voice output setting screen and specifies one of them as the main voice language and the other as the secondary voice language, for example specify Japanese as the main voice language and English as the secondary voice language. In response to that operation, the microcomputer 20 stores in its built-in memory (not shown) the voice output data which have been selected and specified.

When the user operates the reproduction key 30d of the remote control 30 to instruct reproduction of signals recorded on the optical disc 2 and initiate dubbing of the audio/video signals to the video tape installed in the VTR device 50, the microcomputer 20 supplies control signals to the servo circuit 6 to drive the spindle motor 4 and rotate the optical disc 2, drive the thread motor 5 and move the optical pickup 3 in the radial direction of the optical disc 2, and servo control the tracking and focus of the optical pickup 3, thereby reading out the audio/video signals recorded on the optical disc 2 at high multiplex speed of at least not less than double speed. Then, under the control of the microcomputer 20, the RF amplifier circuit 7 amplifies the RF signals of the audio/video signals, and the decoding/error correcting-circuit 8 synchronously detects and decodes the RF signals of the audio/video signals in response to standard clock signals, and corrects errors in the decoded audio/video signals, and the audio/video signals are reproduced. The stream separation circuit 9 separates the reproduced audio/video signals into video signals and audio signals. The separated video signals are stored in the buffer memory 10 and the separated audio signals are stored in the buffer memory 14.

When the audio signals reproduced from the optical disk 2 are stored in the buffer memory 14, the microcomputer 20 supplies control signals to the audio signal decoder 15 to expand and decode the audio signals which have been compressed in accordance with the predetermined compression system and stored in the buffer memory 14. Next, the microcomputer 20 down-mixes the decoded audio signals and converts the down-mixed audio signals into the monaural main voices signals and the monaural secondary voice signals of the two languages selected in advance, with the main voice signals being stored in the buffer memory 16 and the secondary voice signals being stored in the buffer memory 18.

When the video signals reproduced from the optical disk 2 are stored in the buffer memory 10, the microcomputer 20 supplies control signals to the video signal decoder 11 to expand and decode the video signals which have been compressed in accordance with the predetermined compression system and stored in the buffer memory 10. Then, under the control of the microcomputer 20, the encoder 12 encodes the decoded video signals into video signals of a predetermined signal system such as the NTSC system, and the DA converter circuit 13 converts the encoded video signals to analog signals which, in turn, is outputted to the VTR device 50. When the main voice signal reproduced from the optical disk 2 and down-mixed are stored in the buffer memory 16 and the secondary voice signals reproduced from the optical disk 2 and down-mixed are stored in the buffer memory 18, the microcomputer allows the DA converter circuit 17 to convert the digital monaural main voice signals stored in the buffer memory 16 into analog signals and allows the DA converter circuit 19 to convert the digital monaural secondary voice signals stored in the buffer memory 18 into analog signals, with the main voice and secondary voice signals converted to analog signals being outputted to the VTR device 50 along with the video signals.

The VTR device 50 simultaneously records on the video tape the video signals, the monaural main voice signals and secondary voice signals reproduced from the optical disk signal reproducing device 1 so that the video signals recorded on the optical disc 2 and the audio signals of two languages selected in advance may be dubbed on the video tape.

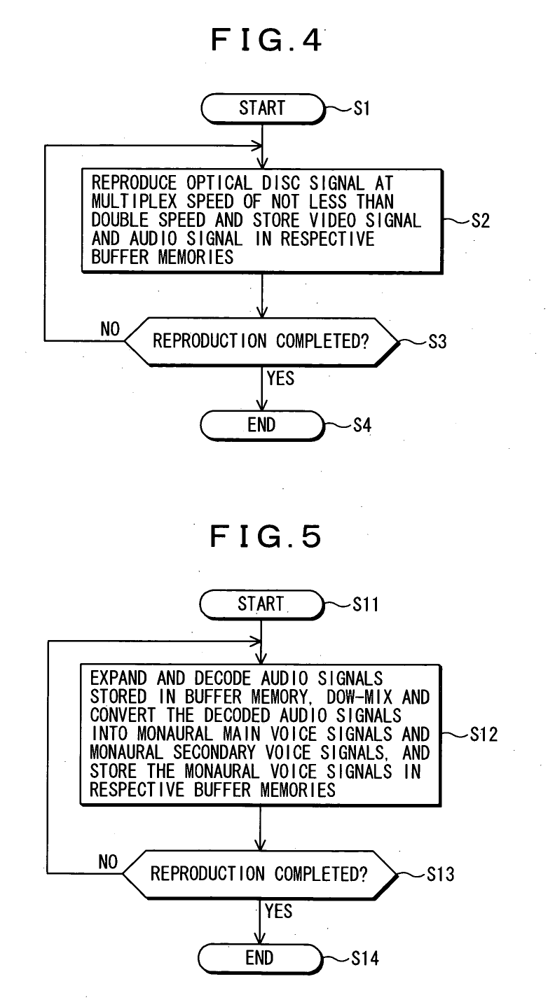

The reproducing and storing operation of the optical disk signal reproducing device 1 of the above mentioned embodiment will be described with reference to the flowchart shown in FIG. 4.

When the reproduction key of the remote control 30 is operated to instruct reproduction of signals recorded on the optical disk 2, the process proceeds from step S1 to step S2 whereat the audio/video signals recorded on the optical disc 2 are reproduced at high multiplex speed, at least not less than double speed, and the reproduced audio/video signals are separated into audio signals and video signals which in turn are stored in respective buffer memories 10 and 14, and the process proceed to step S3.

At step S3, it is determined whether the reproduction of the signals recorded on the optical disk 2 has been completed or not. If the reproduction has been completed, the process proceeds to step S4 whereat the process is terminated. If the reproduction has not been completed, the process return to step S2 and the process from step S2 to step S3 is repeated.

The decoding, converting and storing operation of the optical disk signal reproducing device 1 of the above mentioned embodiment will be described with reference to the flowchart shown in FIG. 5. When the audio signals reproduced from the optical disc 2 are stored in the buffer memory 14, the process proceeds from step S11 to step S12 whereat the audio signals which have been compressed in accordance with the predetermined compression system and stored in the buffer memory 14, are expanded and decoded, and the decoded audio signals are down-mixed and converted into monaural main voice signals and monaural secondary voice signals of two languages selected in advance, with the converted monaural main and secondary voice signals being stored in respective buffer memories 16 and 18 and the process proceeding to step S13. At step S13, it is determined whether the reproduction of the signals recorded on the optical disk 2 has been completed or not. If the reproduction has been completed, the process proceeds to step S14 whereat the process is terminated. If the reproduction has not been completed, the process return to step S12 and the process from step S12 to step S13 is repeated.

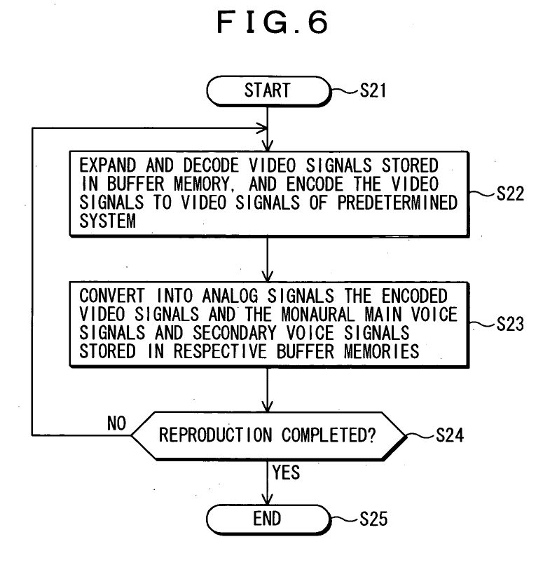

The decoding, encoding and video and audio signal outputting operation of the optical disk signal reproducing device 1 of the above mentioned embodiment will be described with reference to the flowchart shown in FIG. 6.

When the video signals reproduced from the optical disk 2 is stored in the buffer memory 10 and the monaural main voice and secondary voice signals reproduced from the optical disc 2 and down-mixed are stored in respective buffer memories 16 and 18, the process proceed from step S21 to step S22 whereat the video signals which have been compressed in accordance with the predetermined compression system and stored in the buffer memory 10 are expanded and decoded, and encoded to video signals of the predetermined signal system, then the process proceeding to step S23.

At step S23, the video signals encoded in accordance with the predetermined signal system and the monaural main and secondary voice signals stored in respective buffer memories 16 and 18 are respectively converted into analog signals which in turn are outputted, then the process proceeding to step S24. At step S24, it is determined whether the reproduction of the signals recorded on the optical disk 2 has been completed or not. If the reproduction has been completed, the process proceeds to step S25 whereat the process is terminated. If the reproduction has not been completed, the process return to step S22 and the process from step S22 to step S24 is repeated.

According to an aspect of the above-described embodiment of the optical disk signal reproducing device the present invention, a main voice language and a secondary voice language of two languages are selected in advance, audio/video signals recorded on an optical disk are reproduced at high multiplex speed, at least not less than double speed, the reproduced audio/video signals are separated into audio signals and video signals, the video signals are stored in a first buffer memory, the audio signals are stored in a second buffer memory, the video signals stored in the first buffer memory are expanded and decoded, the decoded video signals are encoded to video signals of a predetermined signal system, the encoded video signals are converted into analog signals, the analog signals are outputted, the audio signals stored in the second buffer memory are expanded and decoded, the decoded audio signals are down-mixed and converted into monaural main and secondary voice signals of the two languages selected in advance, the main voice signals are stored in a third buffer memory, the secondary voice signals are stored in a fourth buffer memory, the monaural main voice signals stored in the third buffer memory are converted into analog signals, the analog main voice signals are outputted, the monaural secondary voice signals stored in the fourth buffer memory are converted into analog signals, and the analog secondary voice signals are outputted, so that the video signals reproduced from the optical disc and the voice signals of two languages selected in advance are outputted and dubbed on another recording medium.

According to another aspect of the embodiment of the optical disc signal reproducing device of the present invention, the optical disc signal reproducing device allows a user to select in advance a main voice language and a secondary voice language of two languages, reproduces audio/video signals recorded on an optical disk at high multiplex speed, separates the reproduced audio/video signals into audio signals and video signals, stores the video signals in a first buffer memory, stores the audio signals in a second buffer memory, expands and decodes the video signals stored in the first buffer memory, encodes the decoded video signals to video signals of a predetermined signal system, converts the encoded video signals into analog signals, outputs the analog signals, expands and decodes the audio signals stored in the second buffer memory, down-mixes and converts the decoded audio signals into monaural main and secondary voice signals of the two languages selected in advance, stores the main voice signals in a third buffer memory, stores the secondary voice signals in a fourth buffer memory, converts the monaural main voice signals stored in the third buffer memory into analog signals, outputs the analog main voice signals, converts the monaural secondary voice signals stored in the fourth buffer memory into analog signals, and outputs the analog secondary voice signals, so that the video signals reproduced from the optical disc and the voice signals of two languages selected in advance are outputted and dubbed on another recording medium.

According to still another aspect of the embodiment of the optical disc signal reproducing device of the present invention, audio/video signals recorded on the optical disc are reproduced at high multiplex speed of at least not less than double speed, a single audio decoder may be employed for expansion and decoding of the audio signals, so that cost for the production of the optical disc signal reproducing device can be reduced.

According to yet another aspect of the embodiment of the optical disc signal reproducing device of the present invention, the audio signals stored in the second buffer memory are expanded and decoded, and the decoded audio signals are down-mixed and converted into monaural main voice and secondary voice signals of two languages selected in advance, so that main voice and secondary voice signals of two languages selected in advance may be outputted.

As an embodiment of the present invention has been described, the present invention should not be limited to the embodiment but variations, modifications and improvements therefrom are available by those skilled in the art.

What is claimed is:

1. An optical disc signal reproducing device for reproducing and outputting audio/video signals recorded on an optical disc, comprising
a selection unit for selecting in advance two languages of a main voice and secondary voice;
a reproducing unit for reproducing the audio/video signals recorded on an optical disc at multi-speed of at least not less than double speed;
a stream separating unit for separating the audio/video signals reproduced by the reproducing means into video signals and audio signals;
a first buffer unit for storing the video signals separated by the stream separating unit;
a second buffer unit for storing the audio signals separated by the stream separating unit;
a first decoding unit for expanding and decoding the video signals stored in the first buffer unit;
an encoding unit for encoding the video signals decoded by the first decoding unit to video signals of a predetermined signal system;
a first DA converting unit for converting the video signals encoded by the first encoding unit to analog signals and outputting the analog signals;
a second decoding unit for expanding and decoding the audio signals stored in the second buffer unit and down-mixing and converting the decoded audio signals into monaural main and secondary voice signals of the two languages selected in advance by the selection unit;
a third buffer unit for storing the main voice signals converted into the monaural signals by the second decoding unit;
a fourth buffer unit for storing the secondary voice signals converted into the monaural signals by the second decoding unit;
a second DA converting unit for converting the monaural main voice signals stored in the third buffer unit into analog signals and outputting the analog signals; and
a third DA converting unit for converting the monaural secondary voice signals stored in the fourth buffer unit into analog signals and outputting the analog signals.

2. An optical disc signal reproducing device for reproducing and outputting audio/video signals recorded on an optical disc, comprising
a selection unit for selecting in advance two languages of a main voice and secondary voice,
a reproducing unit for reproducing the audio/video signals recorded on an optical disc at multi-speed,
a stream separating unit for separating the audio/video signals reproduced by the reproducing means into video signals and audio signals;
a first buffer unit for storing the video signals separated by the separating unit;
a second buffer unit for storing the audio signals separated by the separating unit;
a first decoding unit for expanding and decoding the video signals stored in the first buffer unit;
an encoding unit for encoding the video signals decoded by the first decoding unit to video signals of a predetermined signal system
a first DA converting unit for converting the video signals encoded by the first encoding unit to analog signals and outputting the analog signals;
a second decoding unit for expanding and decoding the audio signals stored in the second buffer unit and converting the decoded audio signals into monaural main and secondary voice signals of the two languages selected in advance by the selection unit;
a third buffer unit for storing the main voice signals converted into the monaural signals by the second decoding unit;
a fourth buffer unit for storing the secondary voice signals converted into the monaural signals by the second decoding unit;
a second DA converting unit for converting the monaural main voice signals stored in the third buffer unit into analog signals and outputting the analog signals; and
a third DA converting unit for converting the monaural secondary voice signals stored in the fourth buffer unit into analog signals and outputting the analog signals.

3. The optical disc signal reproducing device according to claim 2, wherein the reproducing unit is adapted to reproduce the audio/video signals recorded on the optical disc at high multiplex speed of at least not less than double speed.

4. The optical disc signal reproducing device according to claim 2, wherein the second decoding means is adapted to expand and decode the audio signals stored in the second buffer memory, and down-mix and convert the decoded audio signals into monaural main voice and secondary voice signals of the two languages selected in advance by the selection unit.

5. A method for reproducing audio/video signals recorded on an optical disc, comprising:
allowing a user to select in advance a main voice language and a secondary voice language of two languages;
reproducing audio/video signals recorded on an optical disk at high multiplex speed;
separating the reproduced audio/video signals into audio signals and video signals;
storing the video signals in a first buffer memory;
storing the audio signals in a second buffer memory;
expanding and decoding the video signals stored in the first buffer memory;
encoding the decoded video signals to video signals of a predetermined signal system;
converting the encoded video signals into analog signals and outputting the analog signals;
expanding and decoding the audio signals stored in the second buffer memory;
down-mixing and converting the decoded audio signals into monaural main and secondary voice signals of the two languages selected in advance;
storing the main voice signals in a third buffer memory;
storing the secondary voice signals in a fourth buffer memory;
converting the monaural main voice signals stored in the third buffer memory into analog signals;
outputting the analog main voice signals;
converting the monaural secondary voice signals stored in the fourth buffer memory into analog signals; and
outputting the analog secondary voice signals.
